(19) United States
(12) Patent Application Publication
(10) Pub. No.: US 2026/0285512 A1
(43) Pub. Date: Sep. 24, 2026

(54) DRONE WITH FOLDING PROPELLERS

(71) Applicant: Sang-Mook LEE, Namyangju-si (KR)

(72) Inventor: Sang-Mook LEE, Namyangju-si (KR)

(21) Appl. No.: 19/479,701

(22) PCT Filed: Apr. 17, 2024
(86) PCT No.: PCT/KR2024/005118

§ 371 Date: Oct. 28, 2025

(30) Foreign Application Priority Data
Apr. 28, 2023 (KR) 10-2023-0056270

(51) Int. Cl. B64U 30/293; B64U 10/16; B64U 20/70; B64U 50/19

(52) U.S. Cl. CPC B64U 30/293; B64U 10/16; B64U 20/70; B64U 50/19

(57) ABSTRACT

A drone with folding propellers, the drone comprising: a main body; first propeller parts in which a plurality of first driving arms are rotatably coupled to the upper surface of the main body and are inserted into the upper surface of the main body or withdrawn to the outside; and a cover part, which is coupled to the upper surface of the main body so as to be movable in the vertical direction, has a space part formed at the lower end thereof so that the inserted first propeller parts can be covered when the cover part is positioned at the lower side, and moves upward so that the first propeller parts can be withdrawn.

### TECHNICAL FIELD

The present invention relates to a drone with folding propellers, and more particularly, to a drone with folding propellers to reduce the volume and prevent damage to the propellers when used for parking, storage and multi-purpose purposes other than driving.

### BACKGROUND ART

Recently, a drone, which originated in the military industry, refers to a flight vehicle having an airplane or helicopter shape that flies by radio frequency guidance without a human being on board.

Recently, drones are widely used for military and commercial purposes, and research thereon is also actively being conducted.

However, due to the increasing demand for drones, the amount of drone traffic in the airspace is anticipated to increase, and accordingly the possibility of collisions and rear-ends during flights of drones has increased. In addition, the possibility of drone crashes is also increasing due to reasons such as poor drone control, battery discharge, and malfunction. In addition, the above-mentioned increasing risks due to using drones may lead to damage to life or property.

In addition, in recent years, the drones have been used in various fields such as logistics delivery, disaster relief, broadcasting and leisure, in addition to military use, due to various advantages such as simplicity, rapidity, and economic feasibility.

In addition, the drones have many advantages, however, it is also true that there is a high risk of crashing due to changes in the external environment, such as wind, and unskilled driving operations. Further, the economic damage caused by drone damage may be serious because the drones and various components thereof are so expensive.

Moreover, when a drone crashes, there may be a significant economic loss due to the damage to the multicopter drone itself, and the secondary damage to people and property may also have a serious risk.

For these reasons, the operational stability of drones has been highlighted, and for the stability, the design especially for the structure of a wing part and a landing part of a drone has been emerged as an important issue.

In other words, for designing the structure of the drone's wing part, both the problem of the drone ascending or descending stably during takeoff and landing, and the operational problem of moving in a specific direction after takeoff are required to must be considered. There is a need for technological development for drones to solve both of the above problems.

In addition, conventional drones have a wing part mostly having shapes integrated with a main body. Since the integrated structure always carries the risk of damage and the like during the transportation process of drones, and there is a need to develop a structure for the wing part capable of preventing the risk.

The related art in the technical field to which the present invention pertains includes, for example, Korean Patent Registration No. 10-2314218, Korean Patent Registration No. 10-2133412, Korean Patent Registration No. 10-1866191 and Korean Patent Registration No. 10-2328509.

### DISCLOSURE

### Technical Problem

The present invention is proposed to solve the above conventional problems, an object of the present invention is to fold the drone's wings so as to minimize the volume during parking or storing and protect the wings from external impact.

In addition, an object of the present invention is to enable stable flight through multiple wings.

### Technical Solution

In order to achieve the above-mentioned objects, a drone with folding propellers according to an exemplary embodiment of the present invention includes: a main body; first propeller parts having a plurality of first driving arms rotatably coupled to an upper surface of the main body so as to be drawn into the upper surface of the main body or drawn to an outside; and a cover part movably coupled to the upper surface of the main body in a vertical direction, formed in a bottom thereof with a space part to cover the drawn-in first propeller parts when being positioned downward, and moved upward to allow the first propeller parts to be drawn out.

In addition, the bottom of the cover part may be formed on a periphery thereof with an angle fixing groove at a position facing the drawn-out first driving arm, so as to be combined with the first driving arm when being moved downward, thereby fixing a drawn-out angle of the first driving arm.

In addition, a lower plate may be coupled to the space part so as to be movable in the vertical direction, the lower plate may have a lower surface to which second propeller parts are coupled to allow a plurality of second driving arms to be rotated, the second driving arms may be positioned on a plane with the first driving arms when the lower plate is moved downward, and the second driving arms may be rotated when the lower plate is moved upward.

In addition, the lower plate may have an upper surface to which an elastic body is coupled so as to be connected to an upper surface of the space part, and the lower plate may be moved downward when the cover part is moved upward, and the lower plate may be pushed by the first propeller parts, moved upward and drawn into the space part when the cover part is moved downward.

In addition, a flight wing may be coupled to an upper surface of the cover part so as to be height-adjustable and rotatable, the flight wing may be formed to correspond to a shape of the upper surface of the cover part, and the flight wing may be rotated after ascending to a predetermined height.

### Advantageous Effects

According to the drone with folding propellers of the present invention, the first propeller parts are rotatably coupled to the upper surface of the main body and drawn in and out and the cover part is movably coupled to the upper surface of the main body in the vertical direction, and thus the first propeller parts are drawn into the cover part according to the rotation of the first propeller parts and the movement of the cover part, so that the volume can be minimized when the drone is parked or stored and propellers can be prevented from being damaged.

In addition, the second propeller parts are rotatably coupled to the lower surface of the cover part, so that more stable flight can be obtained through the first and second propeller parts.

### DESCRIPTION OF DRAWINGS

FIG. 1 is a perspective view of a drone with folding propellers according to a first embodiment of the present invention.

FIG. 2 is a side view of the drone with folding propellers according to the first embodiment of the present invention.

FIG. 3 shows a plan view of a main body and a bottom view of a cover part according to the first embodiment of the present invention.

FIG. 4 is a layout view of first propeller parts and second propeller parts according to the first embodiment of the present invention.

FIGS. 5 to 7 are operation views of the drone with folding propellers according to the first embodiment of the present invention.

FIGS. 8 and 9 are operation views of a flight wing according to the first embodiment of the present invention.

FIG. 10 is a perspective view of a drone with folding propellers according to a second embodiment of the present invention.

FIG. 11 is a side view of the drone with folding propellers according to the second embodiment of the present invention.

FIG. 12 is a view showing a state in which a driving arm is fixed to an angle fixing groove according to the second embodiment of the present invention.

FIG. 13 shows a front view and a bottom view of a sub-fixing groove according to the second embodiment of the present invention.

FIG. 14 shows a front view and a plan view of a fixing plate according to the second embodiment of the present invention.

FIG. 15 shows operation views of a shielding film according to the second embodiment of the present invention.

### BEST MODE

### Mode for Invention

Advantages and features of the present invention, and methods for achieving the advantages and features will be apparent with reference to the embodiments described below in detail with the accompanying drawings.

However, the present invention is not limited to the embodiments disclosed below and may be implemented in various different forms, and these embodiments are provided only to make the disclosure of the present invention complete and to fully inform a person having ordinary skill in the art of the scope of the present invention, and the present invention is defined only by the scope of the claims. The same reference numeral indicates the same element throughout the specification.

Hereinafter, the present invention will be described with reference to the drawings for illustrating a drone with folding propellers according to the embodiments of the present invention.

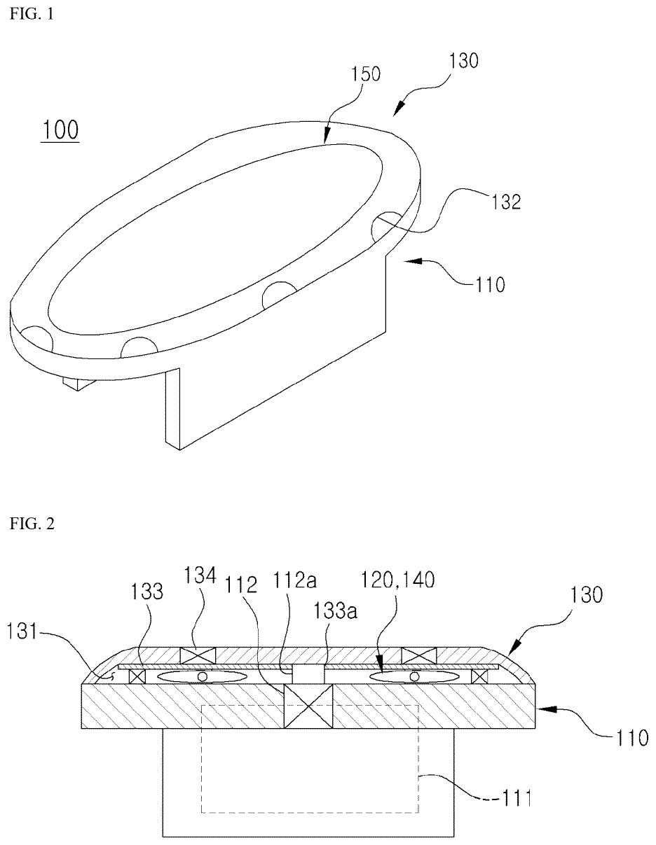

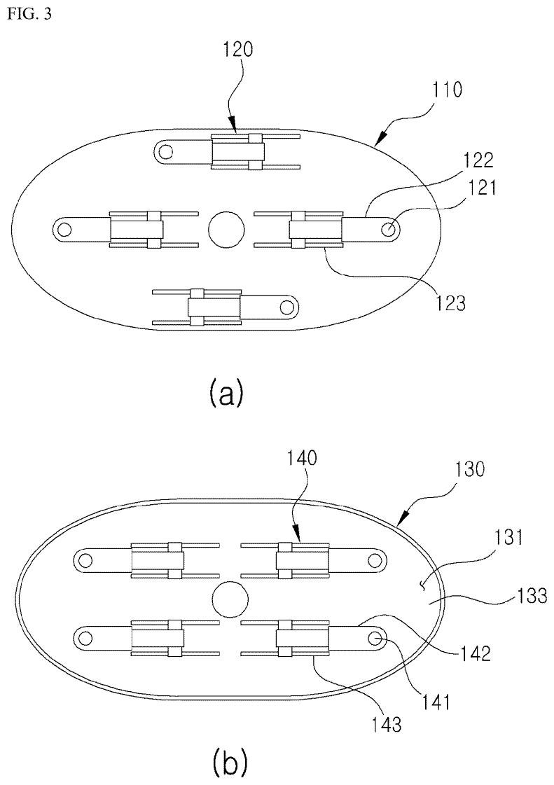

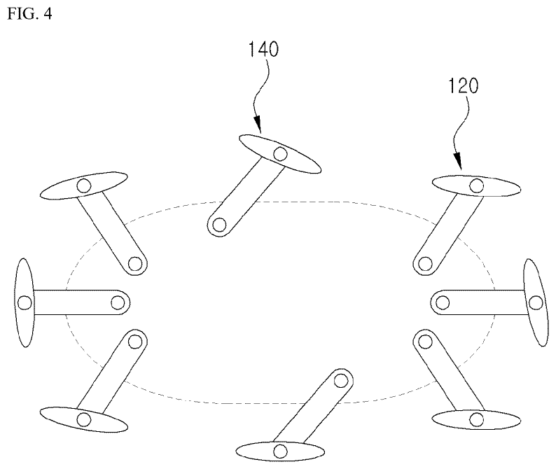

FIG. 1 is a perspective view of a drone with folding propellers according to a first embodiment of the present invention; FIG. 2 is a side view of the drone with folding propellers according to the first embodiment of the present invention; FIG. 3 shows a plan view of a main body and a bottom view of a cover part according to the first embodiment of the present invention;

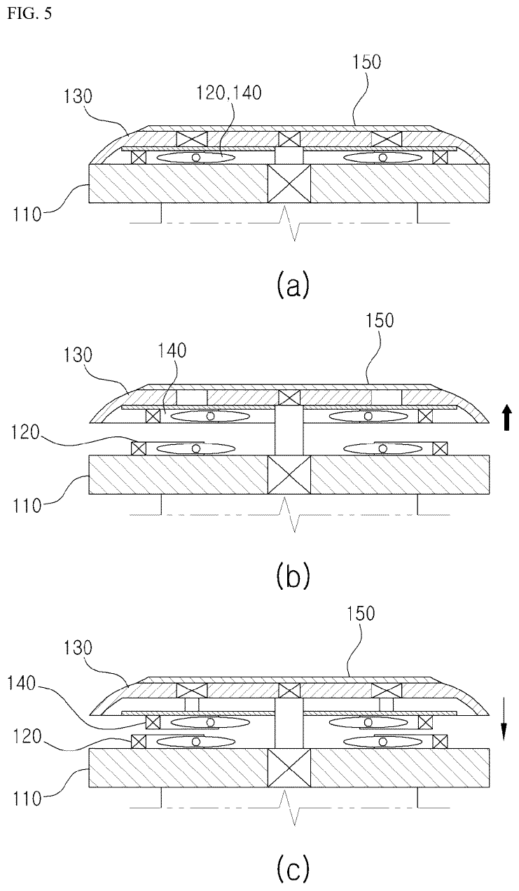

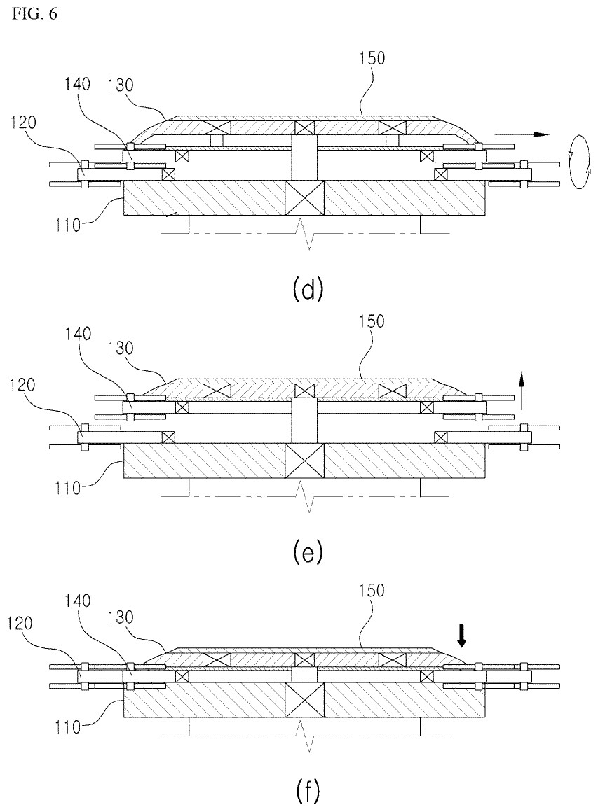

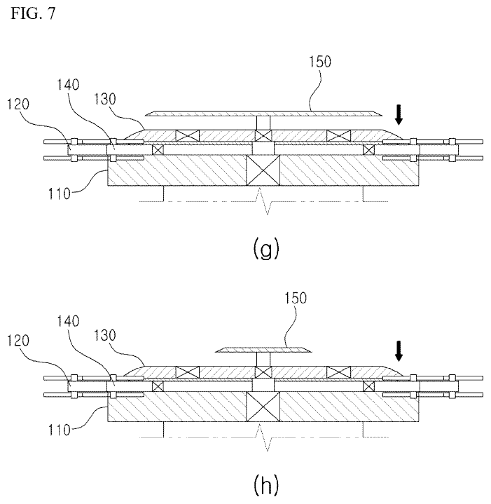

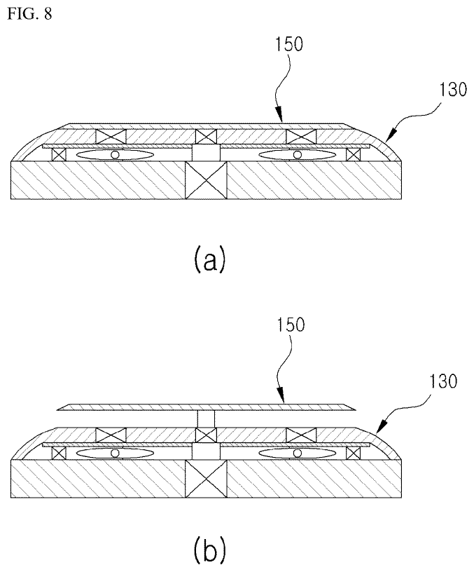

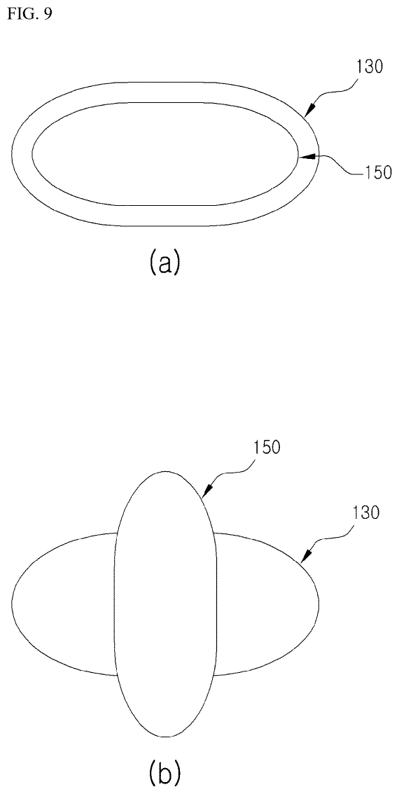

FIG. 4 is a layout view of first propeller parts and second propeller parts according to the first embodiment of the present invention; FIGS. 5 to 7 are operation views of the drone with folding propellers according to the first embodiment of the present invention; and FIGS. 8 and 9 are operation views of a flight wing according to the first embodiment of the present invention.

Referring to the drawings, the drone with folding propellers according to an embodiment of the present invention is configured to have the propeller allowed to be drawn in and out, so that a volume is reduced during storage and wings are prevented from being damaged.

A drone 100 with folding propellers according to an embodiment of the present invention to provide the above advantageous effects includes a main body 110, first propeller parts 120, a cover part 130, and second propeller parts 140.

The main body 110 has a streamlined long shape and is formed in various sizes.

The main body 110 may have a size of a palm for portability, or a large size enough to be combined with a vehicle or carry a human.

Supports are coupled downward from both sides of a bottom of the main body 110.

For example, a buoyant body may be coupled to the supports, or a vehicle may be combined between the supports.

A battery 111 and a first driving cylinder 112 are coupled inside the main body 110.

The battery 111 is coupled to the support.

The battery 111 may be detachably coupled to the support.

The first drive cylinder 112 is configured to move the cover part 130 described later in the vertical direction, and is coupled to a center of the main body 110 so as to have a cylinder rod 112a protruding upward.

The first propeller part 120 is configured to provide thrust to the main body 110, and is coupled to an upper end of the main body 110 and connected to the battery 111.

The first propeller parts 120 are provided with a plurality of first driving motors 121 coupled on an upper surface of the main body 110 at regular intervals.

A body of the first driving motor 121 is coupled to be accommodated into the main body 110.

The first driving motors 121 are arranged along a periphery of the main body 110.

First driving arms 122 are rotatably coupled to the first driving motors 121, respectively.

The first driving arms 122 come close contact with the upper surface of the main body 110 so as to be supported.

Each of the first driving arms 122 is rotated to be positioned and drawn in the upper surface of the main body 110, or is rotated to be drawn outward from the upper surface of the main body 110.

A first propeller 123 is coupled to an end of the first driving arm 122.

The first propeller is doubly coupled to the first driving arm in the vertical direction.

The first driving arm may be preferably formed to have the end to be rotatable, so as to rotate the first propeller upon the drawn-in.

This is to prevent the first propellers doubly arranged in the vertical direction from interfering with the upper surface of the main body when the first driving arm coming into close contact with the upper surface of the main body is drawn in.

When being rotated to be drawn in the main body 110, the first driving arms 122 are arranged to be parallel to each other and arranged to be parallel to the longitudinal direction of the main body 110.

The cover part 130 is configured to cover the drawn-in first propeller parts 120, and is movably coupled to the main body 110 in the vertical direction thereof.

The cover part 130 has a size corresponding to or the same as the upper surface of the main body 110.

A space part 131 is formed at a bottom of the cover part 130 to cover the first propeller part 120.

An angle fixing groove 132 is formed on a lower end periphery of the cover part 130 at a position facing the first driving arm 122 of the first propeller part 120 having been drawn out so as to fix the first driving arm 122.

The angle fixing groove 132 is formed at a position facing the second driving arm 142 described later.

The cover part 130 is moved downward to cover the drawn-in first propeller part 120 through the space part 131.

The cover part 130 is moved upward to allow the first propeller part 120 to be drawn out.

After the first propeller part 120 is drawn out while the cover part 130 being moved upward, the cover part is moved downward to fix the first driving arm 122 through the angle fixing groove 132

In addition, a lower plate 133 is coupled to the space part 131 of the cover part 130 so as to be movable in the vertical direction.

Specifically, the lower plate 133 is formed to correspond to the space part 131, and formed at a center thereof with a through-hole 133a through which the cylinder rod 112a passes.

The lower plate 133 is connected to a second driving cylinder 134 installed on an inner upper surface of the space part 131.

The lower plate 133 is moved in the vertical direction within the space part 131 according to a drive of the second driving cylinder 134.

The lower plate 133 is positioned to come into close contact with an upper end of the first propeller part 120 when the cover portion part 130 is positioned downward.

The second propeller part 140 has the same configuration as the first propeller part 120, and is coupled to a lower surface of the lower plate 133 and connected to the battery 111.

The second propeller parts 140 are provided with a plurality of second driving motors 141 coupled to the lower surface of the lower plate 133 at regular intervals.

The second driving motor 141 is coupled to be accommodated in the lower plate 133.

The second driving motors 141 are arranged along a periphery of the lower plate 133.

The second driving motor 141 may be preferably arranged between the adjacent first driving motors 121 on the periphery of the lower plate 133.

Second driving arms 142 are rotatably coupled to the second driving motors 141, respectively.

The second driving arm 142 comes into close contact with the lower surface of the lower plate 133.

Each of the second driving arms 142 is rotated to be positioned and drawn in the lower surface of the lower plate 133, or is rotated to be drawn outward from the lower plate 133.

A second propeller 143 is coupled to an end of the second driving arm 142.

The first driving arm 122 and the second driving arm 142 may be preferably arranged to be spaced apart from each other at regular intervals.

This is to prevent the first propeller 123 and the second propeller 143 from interfering with each other during operation.

When being rotated to be drawn in the lower plate 133, the second driving arms 142 are arranged to be parallel to each other and arranged to be offset, when viewed from the top, to the first driving arms 122.

When the cover part 130 is moved downward, the second driving arms 142, while being drawn in, are positioned between the first driving arms 122, and positioned to be on a plane with the first driving arms 122.

Meanwhile, the second propeller is doubly coupled to the second driving arm in the vertical direction.

The second driving arm may be preferably formed to have the end to be rotatable, so as to rotate the second propeller upon the drawn-in.

This is to prevent the second propellers doubly arranged in the vertical direction from interfering with the lower surface of the lower plate when the second driving arm coming into close contact with the lower surface of the lower plate is drawn in.

A flight wing 150 formed to correspond to a shape of the upper surface of the cover part 130 is coupled to the upper surface of the cover part 130.

The flight wing 150 is configured to maintain lift even when the propellers stops at a predetermined speed or higher, and is coupled to the upper surface of the cover part 130 so as to be adjusted in height by a separate cylinder.

The flight wing 150 comes into close contact with the upper surface of the cover part 130 to be superposed thereto or is raised to a predetermined height.

The flight wing 150 is rotatably coupled to the cover part 130 by a separate motor.

The flight wing 150 has a rotation radius of 90 degrees and is arranged to face the cover part 130 or protrude from both sides of the cover part according to the rotation.

The flight wing 150 may be preferably driven when the drone flies at a predetermined speed.

Hereinafter, operations of the drone 100 with folding propellers of the present invention will be described.

In order to draw out the first propeller parts 120 and the second propeller parts 140, the cover part 130 is moved upward while the first propeller parts 120 and the second propeller parts 140 are accommodated.

The cover part 130 is moved upward by the first driving cylinder 112, and the lower plate 133 is moved downward by the second driving cylinder 134.

The cover part 130 is moved so that the first propeller parts 120 and the second propeller parts 140 are spaced apart from each other in the vertical direction.

In addition, the first propeller parts 120 and the second propeller parts 140 are each rotated outward to be drawn out.

The first propeller parts 120 and the second propeller parts 140 are spaced apart from each other in the vertical direction so as to be rotated without interfering with each other.

When the lower plate 133 is moved upward while the first propeller parts 120 and the second propeller parts 140 are drawn out, the second driving arm 142 is fixed to the adjacent angle fixing groove 132.

When the cover parts 130 are moved downward, the first driving arm 122 is fixed to the adjacent angle fixing groove 132 and the first propeller parts 120 and the second propeller parts 140 are positioned on the same plane with each other.

In addition, the flight wing 150 is moved upward and rotated by 90 degrees.

Meanwhile, in order to allow the first propeller parts 120 and the second propeller parts 140 to be drawn in, the cover part 130 is moved upward first, and the lower plate 133 is moved downward.

In addition, the first propeller parts 120 and the second propeller parts 140 are separately rotated to be drawn in.

The lower plate 133 is moved upward while the second propeller parts 140 being drawn in, and the cover part 130 is moved downward so that the first propeller parts 120 and the second propeller parts 140 are arranged parallel to each other.

Accordingly, the first propeller parts 120 and the second propeller parts 140 may be accommodated or the drawn-out angle may be fixed as the cover part 130 is moved upward or downward.

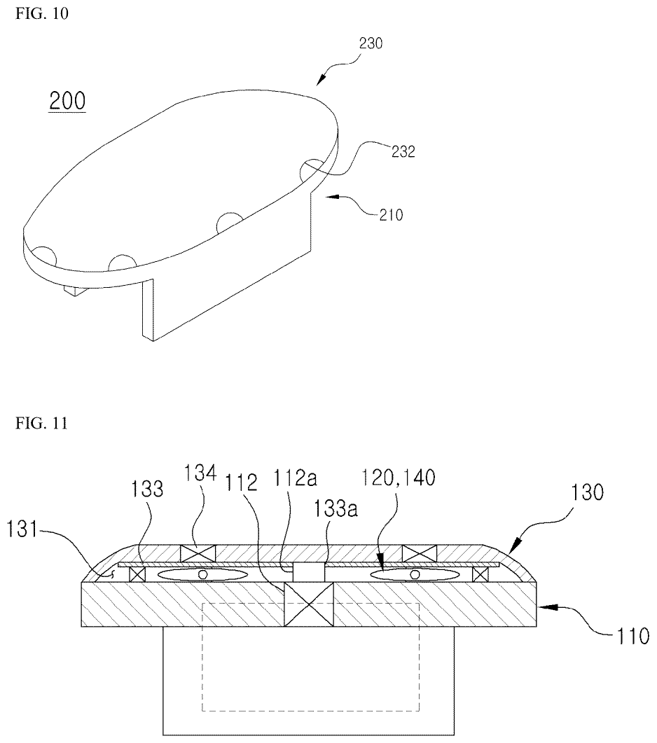

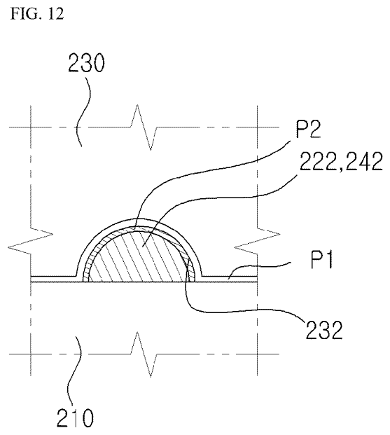

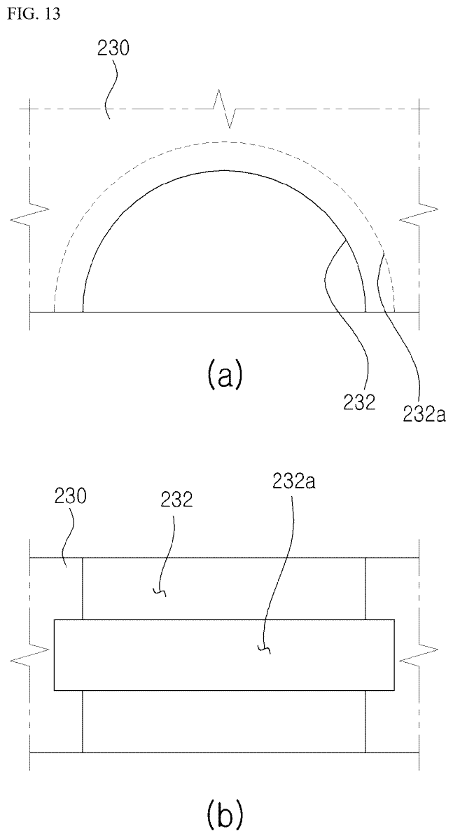

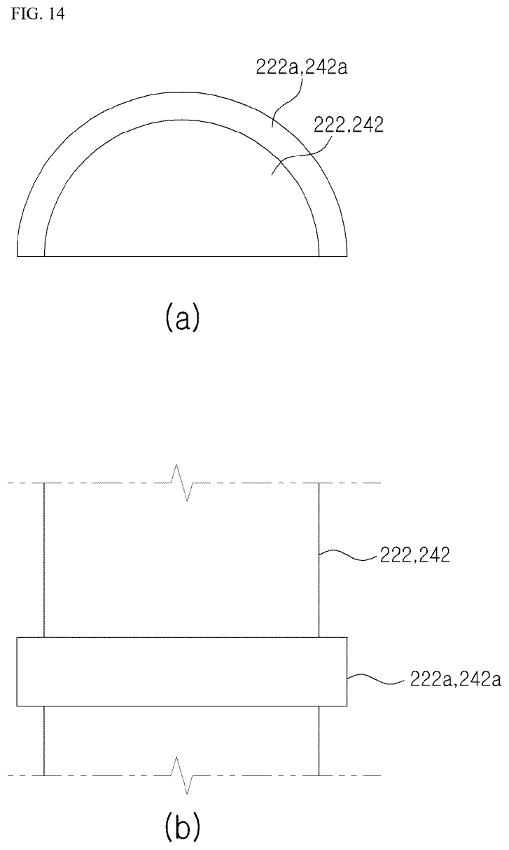

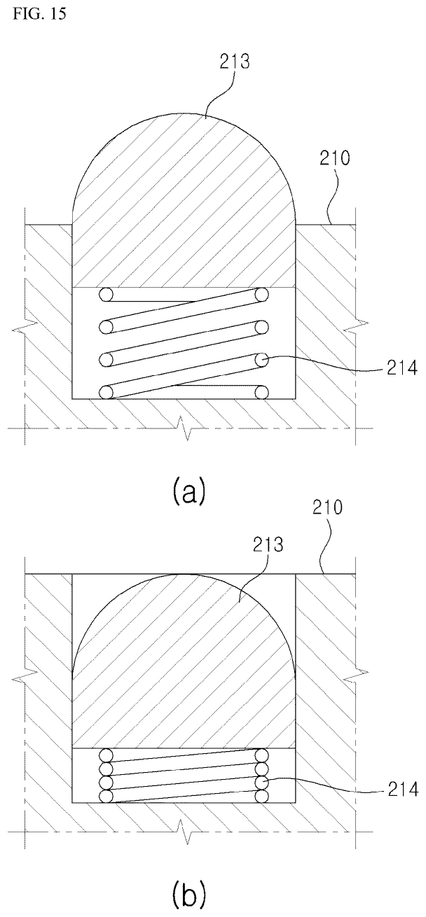

FIG. 10 is a perspective view of a drone with folding propellers according to a second embodiment of the present invention; FIG. 11 is a side view of the drone with folding propellers according to the second embodiment of the present invention; FIG. 12 is a view showing a state in which a driving arm is fixed to an angle fixing groove according to the second embodiment of the present invention; FIG. 13 shows a front view and a bottom view of a sub-fixing groove according to the second embodiment of the present invention; FIG. 14 shows a front view and a plan view of a fixing plate according to the second embodiment of the present invention; and FIG. 15 shows operation views of a shielding film according to the second embodiment of the present invention.

A drone 200 with folding propellers according to the embodiment of the present invention includes a main body 210, first propeller parts 220, a cover part 230, and second propeller parts 240.

The first propeller parts 220 are coupled to an upper end of the main body 210.

The first propeller parts 220 are provided with a plurality of first driving motors 221 coupled on an upper surface of the main body 210 at regular intervals.

First driving arms 222 are rotatably coupled to the first driving motors 221, respectively.

Each of the first driving arms 222 is rotated to be positioned and drawn in the upper surface of the main body 210, or is rotated to be drawn outward from the upper surface of the main body 210.

A first propeller 223 is coupled to an end of the first driving arm 222.

The cover part 230 is configured to cover the drawn-in first propeller parts 220, and is movably coupled to the main body 210 in the vertical direction thereof.

A space part 231 is formed at a bottom of the cover part 230 to cover the first propeller parts 220.

An angle fixing groove 232 is formed on a lower end periphery of the cover part 230 at a position facing the first driving arm 222 of the first propeller part 220 having been drawn out so as to fix the first driving arm 222.

The angle fixing groove 232 is formed at a position facing the second driving arm 242 described later.

The angle fixing groove 232 is formed to correspond to the first driving arm 222 and the second driving arm 242.

In addition, a lower plate 233 is coupled to the space part 231 of the cover part 230 so as to be movable in the vertical direction.

The second propeller parts 240 is coupled to a lower surface of the lower plate 233.

The second propeller parts 240 are provided with a plurality of second driving motors 241 coupled to the lower surface of the lower plate 233 at regular intervals.

Second driving arms 242 are rotatably coupled to the second driving motors 241, respectively.

Each of the second driving arms 242 is rotated to be positioned and drawn in the lower surface of the lower plate 233, or is rotated to be drawn outward from the lower plate 233.

A second propeller 243 is coupled to an end of the second driving arm 242.

Further, a sub-fixing groove 232a is formed along an inner wall in the angle fixing groove 232.

A first fixing plate 222a and a second fixing plate 242a are formed on the first driving arm 222 and the second driving arm 242, respectively, so as to be coupled to the sub-fixing groove 232a at a position corresponding to the sub-fixing groove 232a.

In addition, a first packing member P1 is coupled to the lower periphery of the cover part 230 so as to be tightly sealed against the upper surface of the main body 210 to suppress wind noise and prevent moisture and rainwater from entering inward.

Preferably, the first packing member PI may also be formed in the angle fixing groove 232.

In addition, a second packing member P2 is coupled to the upper end of the first driving arm 222 and the lower end of the second driving arm 242.

The second packing member P2 reduces impact and suppresses noise when the first driving arm 222 comes into close contact with the lower plate 233 or when the second driving arm 242 comes into close contact with the main body 210.

A shielding film 213 is coupled to the upper surface of the main body 210 at a position facing the angle fixing groove 232 so as to be elastically drawn in and out, thereby shielding the angle fixing groove when being drawn out.

An elastic body 214 is coupled to a lower end of the shielding film 213.

The shielding film 213 is drawn out upward by elasticity and drawn inward when being pressurized by external force.

The shielding film 213 has a semicircular shape so as to be pressed by an adjacent first driving arm 222 upon rotation of the adjacent first driving arm 222 and drawn into the main body 210

The first driving arm 222, the second driving arm 242 and the angle fixing groove are also formed to have the same shape.

According to the drone with folding propellers of the present invention, the first propeller parts are rotatably coupled to the upper surface of the main body and drawn in and out and the cover part is movably coupled to the upper surface of the main body in the vertical direction, and thus the first propeller parts are drawn into the cover part according to the rotation of the first propeller parts and the movement of the cover part, so that the volume can be minimized when the drone is parked or stored and propellers can be prevented from being damaged.

In addition, the second propeller parts are rotatably coupled to the lower surface of the cover part, so that more stable flight can be obtained through the first and second propeller parts.

It will be apparent that a person having ordinary skill in the art may carry out various deformations and modifications within the scope without departing from the idea of the present invention, the following claims and equivalents thereof. Therefore, the above-described embodiments will be understood in all respects as illustrative and not restrictive. The scope of the present invention is defined by the following claims rather than the above detailed description, and all deformations or modifications derived from the idea and scope of the claims and their equivalents will be construed as being included in the scope of the present invention.

1. A drone with folding propellers, the drone comprising:
a main body;
first propeller parts having a plurality of first driving arms rotatably coupled to an upper surface of the main body so as to be drawn into the upper surface of the main body or drawn to an outside; and
a cover part movably coupled to the upper surface of the main body in a vertical direction, formed in a bottom thereof with a space part to cover the drawn-in first propeller parts when being positioned downward, and moved upward to allow the first propeller parts to be drawn out.

2. The drone of claim 1, wherein the bottom of the cover part is formed on a periphery thereof with an angle fixing groove at a position facing the drawn-out first driving arm, so as to be combined with the first driving arm when being moved downward, thereby fixing a drawn-out angle of the first driving arm.

3. The drone of claim 2, wherein a lower plate is coupled to the space part so as to be movable in the vertical direction, the lower plate has a lower surface to which second propeller parts are coupled to allow a plurality of second driving arms to be rotated, the second driving arms are positioned on a plane with the first driving arms when the lower plate is moved downward, and the second driving arms are rotated when the lower plate is moved upward.

4. The drone of claim 3, wherein the lower plate has an upper surface to which an elastic body is coupled so as to be connected to an upper surface of the space part, and the lower plate is moved downward when the cover part is moved upward, and the lower plate is pushed by the first propeller parts, moved upward and drawn into the space part when the cover part is moved downward.

5. The drone of claim 1, wherein a flight wing is coupled to an upper surface of the cover part so as to be height-adjustable and rotatable, the flight wing is formed to correspond to a shape of the upper surface of the cover part, and the flight wing is rotated after ascending to a predetermined height.
